(19) United States
(12) Patent Application Publication
(10) Pub. No.: US 2010/0195980 A1
(43) Pub. Date: Aug. 5, 2010

(54) INFORMATION STORAGE MEDIUM, REPRODUCING APPARATUS, AND REPRODUCING METHOD

(76) Inventors: Kil-Soo JUNG, Osan-si (KR); Jung-wan Ko, Suwon-si (KR); Sung-wook Park, Seoul (KR)

Correspondence Address: North Star Intellectual Property Law, PC, P.O. Box 34688, Washington, DC, 20043, US

(21) Appl. No.: 12/704,576

(22) Filed: Feb. 12, 2010

Related U.S. Application Data
(63) Continuation of application No. PCT/KR2008/001814, filed on Apr. 1, 2008.

(30) Foreign Application Priority Data
Aug. 13, 2007 (KR) 10-2007-0081446
Dec. 12, 2007 (KR) 10-2007-0129085

(51) Int. Cl. H04N 7/00

(52) U.S. Cl. 386/96; 386/E05.003

(57) ABSTRACT

A reproducing medium and apparatus to help guarantee reproduction compatibility are provided. An information storage medium to be reproduced by the reproducing apparatus includes audio/video (AV) data, an interactive content used to perform interactions with users, and interactive content management information used to manage the interactive content, wherein the interactive content management information includes information regarding an application to be executed by the reproducing apparatus and information regarding a substitution application substituted for the application.

### CROSS REFERENCE TO RELATED APPLICATION

This application is a continuation of and claims the benefit under 35 U.S.C. §119 of a PCT Patent Application No. PCT/KR2008/001814, filed on Apr. 1, 2008, which claims benefit of a Korean Patent Application No. 10-2007-0081446, filed on Aug. 13, 2007, and a Korean Patent Application No. 10-2007-0129085, filed on Dec. 12, 2007, the entire disclosures of which are incorporated herein by reference for all purposes.

### BACKGROUND

1. Field

The following description relates to an information storage medium, a reproducing apparatus, and a reproducing method thereof. More specifically, the following description relates to a reproduction method of guaranteeing reproduction compatibility according to interactive content required performance grades.

2. Description of the Related Art

In a conventional optical disc which stores an AV stream to reproduce a movie on a screen, program based or markup language based interactive contents may further be stored in addition to the AV stream in order to improve interactions with a user.

Accordingly, a maximum quality of the AV stream is determined in advance according to a type of data stored in the optical disc and an AV application standard defined in a reproducing apparatus to reproduce the data. In addition, the reproducing apparatus typically follows a target decoder model proposed by the AV application standard in order to reproduce the AV stream. Therefore, the AV stream can be reproduced by any apparatus.

However, unlike the AV stream, the interactive contents added to improve interaction with the user may by generated as various types of results according to an ability of a content producer, requirements, or the like, so that the maximum quality of the interactive contents is not limited. Therefore, in the AV application standard including the interactive contents, various grades are defined according to a performance of the reproducing apparatus such as a processing speed of a central processing unit (CPU), a memory capacity, a data input and/or output speed of an added storage medium, and the like so as to enable the content producer to produce the interactive contents in consideration of a performance grade of the reproducing apparatus.

As described above, reproducing apparatuses may be defined by different grades according to the processing speed of the CPU, the memory capacity, the data input and/or output speed of the added storage medium, and the like. Referring to FIG. 1, a conventional high-performance reproducing apparatus 110 and a low-performance reproducing apparatus 120 are illustrated.

As illustrated in FIG. 1, the reproducing apparatuses 110 and 120 may be classified into reproducing apparatuses to reproduce a low-performance application along with an AV stream and reproducing apparatuses capable of further reproducing a high-performance application. Accordingly, the content producer may produce only the low-performance application along with the AV stream, or further produce the high-performance application to produce the optical disc.

Referring to FIG. 1, the high-performance application reproducible AV stream reproducing apparatus 110 can reproduce a disc 2 130 including a high-performance application included title 132 along with an AV stream title 131 and a disc 1 140 including a low-performance application included title 142 along with an AV stream title 141. However, a low-performance application reproducible AV stream reproducing apparatus 120 can reproduce all the titles of the disc 1 140 but cannot properly reproduce a part of the titles of the disc 2 130, that is, the high-performance application included title 132.

As described above, the content producer may produce different grades of optical discs according to performances of the reproducing apparatuses. However, where a user having the low-performance reproducing apparatus attempts to insert therein a high-performance optical disc without the aforementioned information, there is a problem in that the user cannot be provided with all titles produced by the content producer.

### SUMMARY

In one general aspect, there is provided an information storage medium which is to be reproduced by a reproducing apparatus, including AV (audio/video) data, an interactive content used to perform interactions with a user, and interactive content management information used to manage the interactive content, wherein the interactive content management information includes information regarding an application to be executed by the reproducing apparatus and information regarding a substitution application to substitute for the application.

The information regarding the application may include required performance grade information regarding a performance of a reproducing apparatus required to execute the application and position information regarding the application.

The substitution application may be an application which is substituted for the application in response to the reproducing apparatus not satisfying the reproducing apparatus performance required from the required performance grade information.

The information regarding the substitution application may include existence information regarding the substitution application and position information regarding the substitution application.

In another general aspect, there is provided a reproducing apparatus to reproduce an information storage medium storing AV data, including a reader reading the AV data, an interactive content used to perform interactions with a user, and interactive content management information used to manage the interactive content from the information storage medium, and a reproducing unit obtaining information regarding an application to be executed by the reproducing apparatus and information regarding a substitution application to substitute the application from the interactive content management information and to reproduce the application with reference to information regarding the application and information regarding the substitution application.

The information regarding the application may include required performance grade information regarding a performance of a reproducing apparatus required to execute the application and position information regarding the application.

The reproducing apparatus may reproduce the substitution application with reference to the information on the substitution application in response to the reproducing apparatus not satisfying the reproducing apparatus performance required from the required performance grade information.

The information regarding the substitution application may include existence information regarding the substitution application and position information regarding the substitution application.

In response to checking that the substitution application does not exist from the existence information regarding the substitution application, the reproducing unit may reproduce a resident substitution application stored in the reproducing apparatus.

The resident substitution application may include a warning content to inform the user of a problem of content reproduction.

In another general aspect, there is provided a reproducing method of reproducing an information storage medium storing AV data performed by a reproducing apparatus, including reading the AV data, an interactive content used to perform interactions with a user, and interactive content management information used to manage the interactive content from the information storage medium, and obtaining information on an application to be executed by the reproducing apparatus and information regarding a substitution application to substitute for the application from the interactive content management information and reproducing the application with reference to information regarding the application and information regarding the substitution application.

The information regarding the application may include required performance grade information regarding a performance of a reproducing apparatus required to execute the application and position information regarding the application.

The reproducing may include reproducing the substitution application with reference to the information regarding the substitution application in response to the reproducing apparatus not satisfying the reproducing apparatus performance required from the required performance grade information.

The information regarding the substitution application may include existence information regarding the substitution application and position information regarding the substitution application.

The reproducing may include reproducing a resident substitution application stored in the reproducing apparatus in response to checking that the substitution application does not exist from the existence information regarding the substitution application.

The resident substitution application may include a warning content to inform the user of a problem of content reproduction.

Other features and aspects will be apparent from the following detailed description, the drawings, and the claims.

### BRIEF DESCRIPTION OF THE DRAWINGS

FIG. 1 is a diagram illustrating a conventional disc which can be reproduced by a high-performance reproducing apparatus and a low-performance reproducing apparatus.

FIG. 2 illustrates an example of an information storage medium.

FIG. 3 illustrates an example of a detailed structure of interactive content management information illustrated in FIG. 2.

FIG. 4 illustrates an example of a detailed structure of application associated information illustrated in FIG. 3.

FIG. 5 illustrates an example of a detailed structure of substitution application associated information illustrated in FIG. 3.

FIG. 6 illustrates an example of an interactive content management information where a plurality of applications exist.

FIG. 7 is a block diagram illustrating an example of a reproducing apparatus.

FIG. 8 is a flowchart illustrating an example of a reproducing method.

FIG. 9 is a flowchart further illustrating the reproducing method illustrated in FIG. 8.

FIGS. 10A through 10C are diagrams illustrating an example of a screen to execute a substitution application.

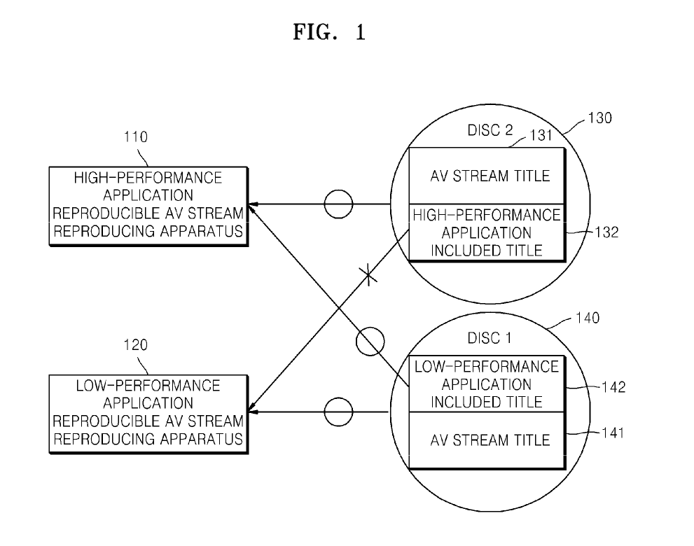

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and constructions may be omitted for increased clarity and conciseness.

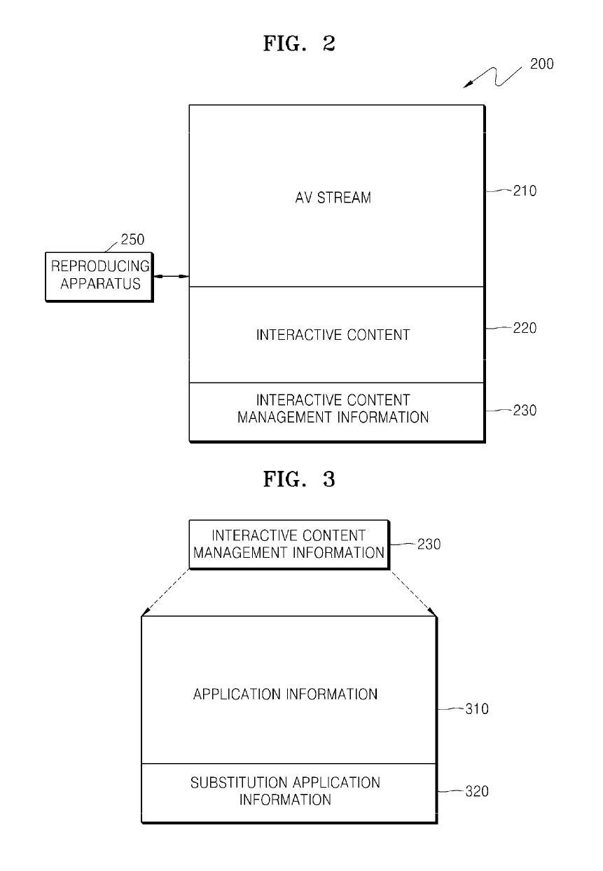

FIG. 2 illustrates an example of an information storage medium 200.

Referring to FIG. 2, the information storage medium 200 includes an audio/video (AV) stream 210, an interactive content 220, and interactive content management information 230.

The AV stream 210 may include AV data including audio and/or video data such as a movie title.

The interactive content 220 may include data to improve interactions between a user and the information storage medium 200 while the AV stream title is reproduced and may include various applications. Examples of the application may include an application to show a caption of a director corresponding to a scene that is being reproduced, an application to show additional information on a region in a scene that is being reproduced, and an application to show additional information on an actor in a scene that is being reproduced.

In addition, the interactive content 220 may further include a substitution application substituted for the application where the application added to a predetermined title cannot be executed.

In the information storage medium 200, the AV stream 210 may include one or more titles, and each title may be a title to reproduce only the AV stream or a title provided with an interactive content in addition to the AV stream. The interactive content management information 230 is information to manage the interactive content 220 and defines information on program or markup language based applications to reproduce interactive content titles. Where the information storage medium 200 includes a plurality of applications, the information storage medium 200 may include interactive content management information 230 corresponding to each of the applications.

The interactive content management information 230 may include information on the substitution application.

Also, the information storage medium 200 may communicate with a reproducing apparatus 250 which reproduces a corresponding application.

FIG. 3 illustrates an example of a detailed structure of the interactive content management information 230.

Referring to FIG. 3, the interactive content management information 230 includes application information 310 and substitution application information 320. The application information 310 may include information to manage the applications included in the interactive content 220, and the substitution application information 320 may include information regarding the substitution application substituted for a corresponding application.

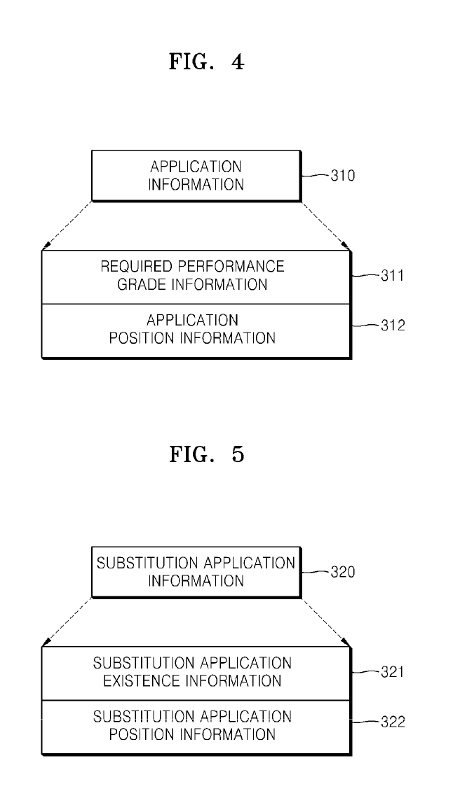

FIG. 4 illustrates an example of a detailed structure of the application associated information 310 illustrated in FIG. 3.

Referring to FIGS. 2, 3 and 4, the application information 310 includes required performance grade information 311 and application position information 312. The required performance grade information 311 may include information regarding a performance of the reproducing apparatus 250 which reproduces the corresponding application, and the application position information 312 may include information regarding a position where a corresponding application is recorded in the information storage medium 200.

Required performance grades described in the required performance grade information 311 may be explained as follows. A grade at which only a movie title can be reproduced but other application titles cannot be reproduced may be known as a grade A, a grade at which a picture in picture (PIP) function and downloading a few pieces of image data are supported in addition to movie title reproduction may be known as a grade B, and a grade at which downloading the entire movie title is supported in addition to the functions supported at the grade B may be known as a grade C.

Where the reproducing apparatus 250 is to reproduce an application, the reproducing apparatus 250 compares a performance of the reproducing apparatus 250 with the required performance grade information 311 stored in the information storage medium 200, and where the performance of the reproducing apparatus 250 satisfies a performance required from the required performance grade information 311, the reproducing apparatus 250 reads the application from a position indicated by the application position information 312 and reproduces the corresponding application. For example, where the performance of the reproducing apparatus 250 is set to the grade A and the required performance grade information 311 of a particular application stored in the information storage medium 200 represents the grade B, the performance of the reproducing apparatus 250 does not satisfy the performance required from the required performance grade information 311, so that the reproducing apparatus 250 determines that the particular application cannot be executed.

FIG. 5 illustrates an example of a detailed structure of the substitution application information 320 illustrated in FIG. 3.

Referring to FIGS. 2, 3 and 5, the substitution application information 320 includes substitution application existence information 321 and substitution application position information 322.

The substitution application existence information 321 may represent whether a substitution application that can be substituted for a corresponding application is stored in the information storage medium 200, and the substitution application position information 322 may indicate a position where the substitution application is stored in the information storage medium 200 where the substitution application exists. For example, where the reproducing apparatus 250 is to reproduce an application, the performance of the reproducing apparatus 250 is compared with the required performance grade information 311 stored in the information storage medium 200. Where the performance of the reproducing apparatus 250 satisfies the performance required from the required performance grade information 311, the reproducing apparatus 250 reads the application from the position indicated by the application position information to reproduce the corresponding application. However, where the performance of the reproducing apparatus 250 does not satisfy the performance required from the required performance grade information 311, the corresponding application cannot be reproduced. Therefore, it is verified whether a substitution application is stored in the information storage medium 200 with reference to the substitution application existence information 321. Where the substitution application exists, the reproducing apparatus 250 reads the substitution application from a position indicated by the substitution application position information 322 and reproduces the substitution application.

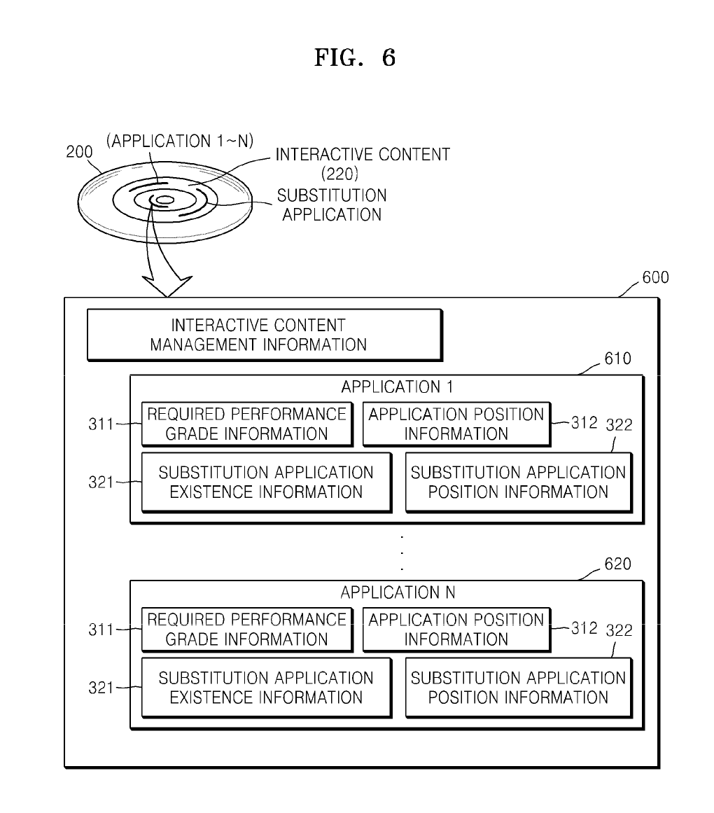

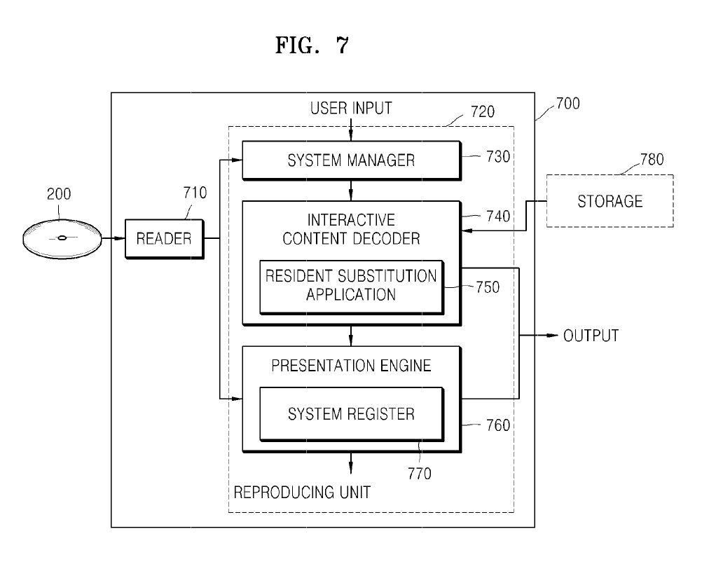

FIG. 6 illustrates an example of an interactive content management information 600 where a plurality of applications exist.

Referring to FIGS. 2, 3 and 6, the information storage medium 200 stores first to N-th applications as the interactive content 220, and stores information to manage each of the N applications as the interactive content management information 230. Specifically, information 610 to manage the first application includes required performance grade information 311 which represents performance information regarding the reproducing apparatus 250 which reproduces the first application, application position information 312 which indicates a position where the first application is stored, substitution application existence information 321 which represents whether a substitution application that is substituted where the reproducing apparatus 250 does not satisfy the performance condition to reproduce the first application is stored in the information storage medium 200, and substitution application position information 322 which indicates a position of the substitution application where the substitution application substituted for the first application is stored. Similarly, information 620 to manage the N-th application includes required performance grade information 311 which represents performance information on the reproducing apparatus 250 required to reproduce the N-th application, application position information 312 which indicates a position where the N-th application is stored, substitution application existence information 321 which represents whether a substitution application that is substituted where the reproducing apparatus 250 does not satisfy the performance condition to reproduce the first application is stored in the information storage medium 200, and substitution application position information 322 which indicates a position of the substitution application where the substitution application substituted for the first application is stored.

FIG. 7 illustrates an example of a reproducing apparatus 700.

Referring to FIGS. 2 and 7, the reproducing apparatus 700 includes a reader 710 and a reproducing unit 720.

The reader 710 reads AV data, an interactive content, and interactive management information from the information storage medium 200 so as to be transmitted to the reproducing unit 720.

The reproducing unit 720 receives the AV data, the interactive content, and the interactive content management information through the reader 710 and reproduces the received AV data and the interactive content. Particularly, the reproducing unit 720 obtains information regarding an application to be executed by the reproducing apparatus 700 and information regarding a substitution application substituted for the application from the interactive content management information and reproduces the application with reference to the information on the application and the information regarding the substitution application.

More specifically, the reproducing unit 720 includes a system manager 730, an interactive content decoder 740, and a presentation engine 760, and may also include a storage space to store a resident substitution application.

The system manager 730 controls the interactive content decoder 740 according to title information and processes a user input.

The interactive content decoder 740 controls the presentation engine 760 according to an application programming interface (API) to perform AV stream reproduction control and executes an application needed to reproduce a corresponding title. According to FIGS. 2, 3, 4 and 7, where the interactive content decoder 740 is to reproduce a title added to an application, the interactive content decoder 740 compares information on the corresponding application, that is, the required performance grade information 311 with information on a performance grade stored in the system register 770 to determine whether the reproducing apparatus 700 satisfies the required performance to reproduce the corresponding application. According to a result of the determining, where the reproducing apparatus 700 satisfies the required performance, the interactive content decoder 740 reads and reproduces the corresponding application from the information storage medium 200, and otherwise, the interactive content decoder 740 determines whether a substitution application exists in the information storage medium 200 with reference to the substitution application existence information 321. According to a result of the determining, where the application exists in the information storage medium 200, the substitution application is read to be reproduced. According to the result of the determining, where the substitution application does not exist in the information storage medium 200, it is checked whether a resident substitution application exists in the reproducing apparatus 700. Where the resident substitution application exists, the corresponding resident substitution application may be executed.

As described above, according to FIGS. 2, 3, 4, and 7, the reproducing apparatus 700 further includes the resident substitution application 750 substituted for a high-performance application where the interactive content decoder 740 or the additional storage has to reproduce information storage medium 200 including the high-performance application that cannot be reproduced by the corresponding reproducing apparatus 700. An example of the resident substitution application 750 may be a warning content which informs users of a problem of reproduction of a part of contents. However, the resident substitution application 750is not limited thereto, but may be modified in any type of application.

The presentation engine 760 includes an audio/video decoder to reproduce the AV stream, and the system register 770 includes information on the performance grade of the corresponding reproducing apparatus 700. In addition, the presentation engine 760 may further include various decoders to decode and reproduce additional data included in the information storage medium 200 such as a subtitle decoder and a menu decoder.

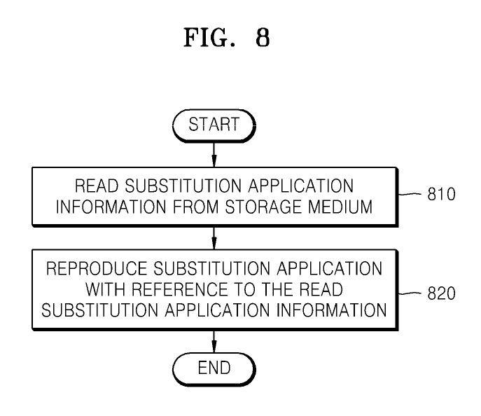

FIG. 8 illustrates an example of a reproducing method.

Referring to FIGS. 7 and 8, the reader 710 of the reproducing apparatus 700 reads the AV data, an interactive content used to perform interactions with users, and interactive content management information used to manage the interactive content from information storage medium at 810.

At 820, the reproducing unit 720 obtains information on an application to be executed by the reproducing apparatus 700 and information on a substitution application substituted for the application from the interactive content management information and reproduces the application with reference to the information on the application and the information on the substitution application.

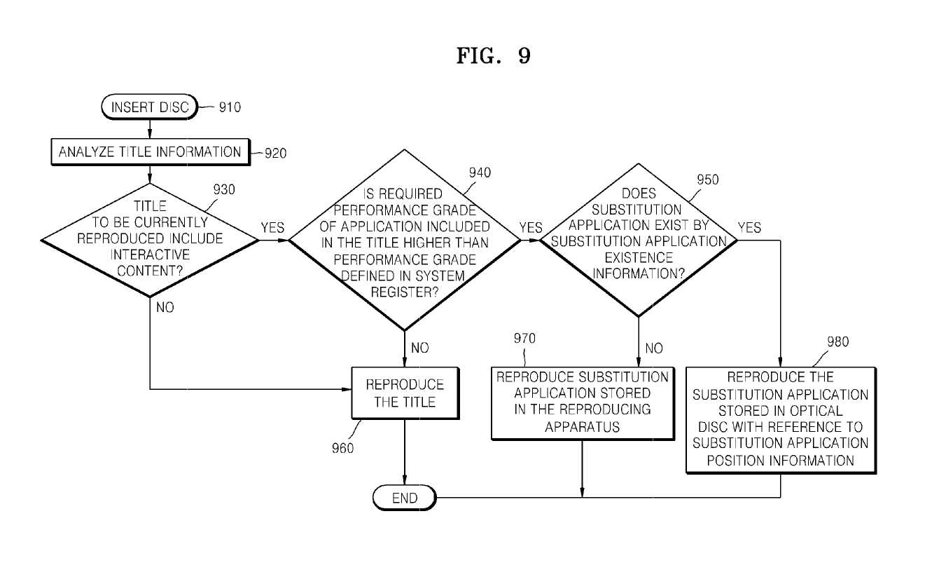

FIG. 9 further illustrates the reproducing method illustrated in FIG. 8.

Referring to FIGS. 2 and 7 through 9, a disc that represents the information storage medium 200 is inserted into the reproducing apparatus 700 at 910. The reproducing apparatus 700 analyzes title information and determines whether a title to be currently reproduced includes an interactive content at 930.

Where the interactive content is not included, the title is reproduced at 960, and the operation is terminated.

When the interactive content is included, it is determined whether a required performance grade of an application included in the title is higher than a performance grade defined in the system register 770 of the reproducing apparatus 700 at 940.

According to a result of the determining, where the required performance grade of the application included in the title is not higher than the performance grade defined in the system register 770, the title and the application included in the title are reproduced at 960, and the operation is terminated.

According to the result of the determining, where the required performance grade of the application included in the title is not higher than the performance grade defined in the system register 770, it is checked whether a substitution application exists by substitution application existence information.

According to a result of the checking, where the substitution application does not exist in the disc, a resident substitution application 750 stored in the reproducing apparatus 700 is reproduced at 970.

According to the result of the checking, where the substitution application exists in the disc, the substitution application stored in the disc is reproduced with reference to substitution application position information at 980.

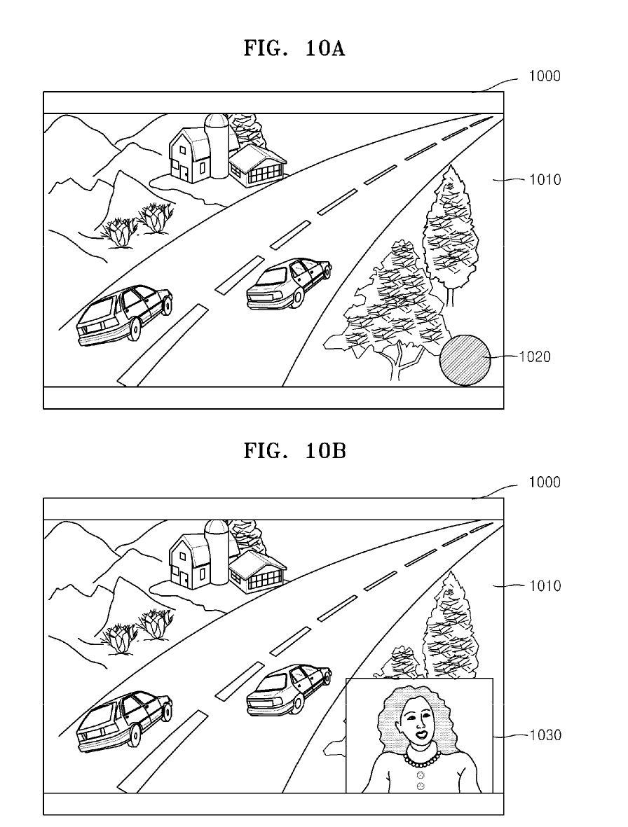

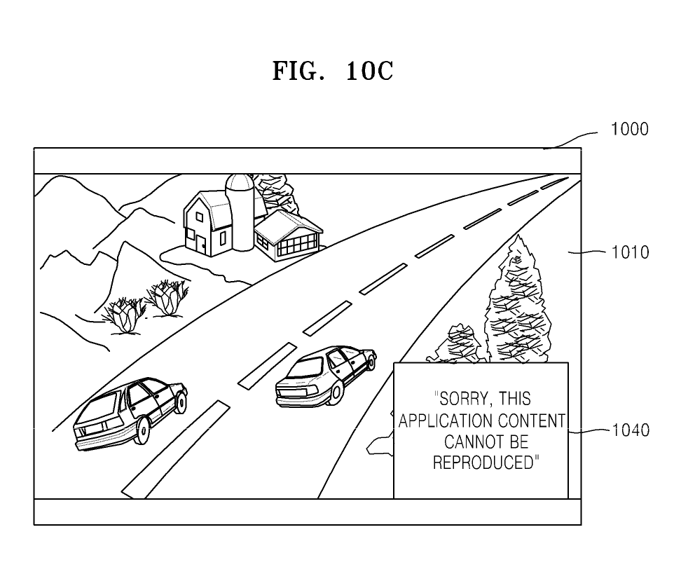

FIGS. 10A through 10C are views illustrating an example of a screen to execute the substitution application.

Referring to FIG. 10A, AV data 1010 is reproduced on a screen 1000 of a display apparatus connected to the reproducing apparatus, and an icon 1020 used to start execution of an application associated with the AV data that is being reproduced is provided at a lower right portion of the screen 1000. Where the user selects the icon 1020 by using an input device or the like to execute the application, the reproducing apparatus determines whether the corresponding application is to be reproduced with reference to information on the application.

Where it is determined that the reproducing apparatus satisfies a performance of a reproducing apparatus corresponding to the corresponding application, the reproducing apparatus reads the corresponding application and reproduces the screen 1000. Referring to FIG. 10B, for example, an application 1030 that is being reproduced shows a director who explains the AV data that is being reproduced as a PIP type.

Where the current reproducing apparatus does not satisfy the performance of the reproducing apparatus corresponding to the corresponding apparatus, the reproducing apparatus checks whether a substitution application substituted for the corresponding application exists in an information storage medium, and where the substitution application exists, the reproducing apparatus executes the substitution application on the screen. However, where the substitution application does not exist in the information storage medium and a substitution application stored in the reproducing apparatus exists, the reproducing apparatus executes the stored substitution application. For example, the substitution application may be an application 1040 to output a warning message that “Sorry, this application content cannot be reproduced” as illustrated in FIG. 10C.

Accordingly, by defining the substitution application, a problem of reproduction due to the performance grade of the reproducing apparatus can be decreased, and the preparation of an interactive content requiring a higher performance is possible.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

Also, the exemplary embodiments described above may be applied where contents included in the reproducing apparatus and the optical disc are changed according to a profile such as BD-JAVA of a BD-ROM player.

The above-described certain exemplary embodiments provide an information storage medium, a reproducing apparatus, and a reproducing method capable of reducing user inconveniences in consideration of cases where not all of titles provided by a content producer are executed according to a performance of the reproducing apparatus.

As stated above, a low-performance reproducing apparatus may not reproduce a part of titles or any title of a high-performance optical disc due to a performance of the reproducing apparatus. Accordingly, according to certain examples described above, where interactive contents are included in the optical disc, in addition to performance information required by an application, a substitution application may be additionally produced for a reproducing apparatus that cannot satisfy corresponding required performance information. In order to apply this, substitution application existence information and substitution application position information are additionally defined in interactive content management information. In addition, where the reproducing apparatus to reproduce the optical disc is to reproduce an optical disc including an application requiring a higher performance, the reproducing apparatus perceives the substitution application existence information. Accordingly, where the substitution application exists, the reproducing apparatus reproduces the corresponding substitution application by using the substitution application position information, and where the additionally produced substitution application does not exist in the optical disc, the reproducing apparatus reproduces a resident substitution application defined in the reproducing apparatus in advance.

Accordingly, user inconveniences can be avoided. In the above description, a term “application” is mainly used. However, the present invention is not limited thereto, and the term “application” may include any contents to provide interactive functions.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. An information storage medium which is to be reproduced by a reproducing apparatus, comprising:
AV (audio/video) data;
an interactive content used to perform interactions with a user; and
interactive content management information used to manage the interactive content,
wherein the interactive content management information includes information regarding an application to be executed by the reproducing apparatus and information regarding a substitution application to substitute for the application.

2. The information storage medium of claim 1, wherein the information regarding the application includes required performance grade information regarding a performance of a reproducing apparatus required to execute the application and position information regarding the application.

3. The information storage medium of claim 2, wherein the substitution application is an application which is substituted for the application in response to the reproducing apparatus not satisfying the reproducing apparatus performance required from the required performance grade information.

4. The information storage medium of claim 1, wherein the information regarding the substitution application includes existence information regarding the substitution application and position information regarding the substitution application.

5. A reproducing apparatus to reproduce an information storage medium storing AV data, comprising:
a reader reading the AV data, an interactive content used to perform interactions with a user, and interactive content management information used to manage the interactive content from the information storage medium; and
a reproducing unit obtaining information regarding an application to be executed by the reproducing apparatus and information regarding a substitution application to substitute the application from the interactive content management information and to reproduce the application with reference to information regarding the application and information regarding the substitution application.

6. The reproducing apparatus of claim 5, wherein the information regarding the application includes required performance grade information regarding a performance of a reproducing apparatus required to execute the application and position information regarding the application.

7. The reproducing apparatus of claim 6, wherein the reproducing apparatus reproduces the substitution application with reference to the information on the substitution application in response to the reproducing apparatus not satisfying the reproducing apparatus performance required from the required performance grade information.

8. The reproducing apparatus of claim 7, wherein the information regarding the substitution application includes existence information regarding the substitution application and position information regarding the substitution application.

9. The reproducing apparatus of claim 8, wherein, in response to checking that the substitution application does not exist from the existence information regarding the substitution application, the reproducing unit reproduces a resident substitution application stored in the reproducing apparatus.

10. The reproducing apparatus of claim 9, wherein the resident substitution application includes a warning content to inform the user of a problem of content reproduction.

11. A reproducing method of reproducing an information storage medium storing AV data performed by a reproducing apparatus, comprising:
reading the AV data, an interactive content used to perform interactions with a user, and interactive content management information used to manage the interactive content from the information storage medium; and
obtaining information on an application to be executed by the reproducing apparatus and information regarding a substitution application to substitute for the application from the interactive content management information and reproducing the application with reference to information regarding the application and information regarding the substitution application.

12. The reproducing method of claim 11, wherein the information regarding the application includes required performance grade information regarding a performance of a reproducing apparatus required to execute the application and position information regarding the application.

13. The reproducing method of claim 12, wherein the reproducing comprises reproducing the substitution application with reference to the information regarding the substitution application in response to the reproducing apparatus not satisfying the reproducing apparatus performance required from the required performance grade information.

14. The reproducing method of claim 13, wherein the information regarding the substitution application includes existence information regarding the substitution application and position information regarding the substitution application.

15. The reproducing method of claim 14, wherein the reproducing comprises reproducing a resident substitution application stored in the reproducing apparatus in response to checking that the substitution application does not exist from the existence information regarding the substitution application.

16. The reproducing method of claim 15, wherein the resident substitution application includes a warning content to inform the user of a problem of content reproduction.
